(19) United States
(12) Patent Application Publication
(10) Pub. No.: US 2025/0276831 A1
(43) Pub. Date: Sep. 4, 2025

(54) PAINT CAN POUR SPOUT DEVICE

(71) Applicant: Kim Sorensen, Whitby (CA)

(72) Inventor: Kim Sorensen, Whitby (CA)

(21) Appl. No.: 19/049,608

(22) Filed: Feb. 10, 2025

Related U.S. Application Data
(60) Provisional application No. 63/559,487, filed on Feb. 29, 2024.

(51) Int. Cl. B65D 25/48; B44D 3/12

(52) U.S. Cl. CPC B65D 25/48; B44D 3/127; B44D 3/128

(57) ABSTRACT

A paint can pour spout device is provided. The device is comprised of a body with a half-circular shape and an integrated spout, designed for attachment to a paint can rim. The body may be formed from materials like plastic or metal, with optional protective coatings to prevent paint adhesion and ease cleaning. The device features various fasteners, including clips, flexible sections, or grooves, to secure it to the paint can, with gaskets enhancing the seal and reducing spillage. The spout is adjustable in size for different flow rates, and may include a pressure release valve to ensure smooth pouring. A removable cap can also be attached to prevent drying or spillage. The method of use involves attaching the device to a paint can, pouring paint, and optionally covering the spout with the cap.

### CROSS-REFERENCE TO RELATED APPLICATION

The present application claims priority to, and the benefit of, U.S. Provisional Application No. 63/559,487, which was filed on Feb. 29, 2024, and is incorporated herein by reference in its entirety.

### FIELD OF THE INVENTION

The present invention relates generally to the field of paint can attachments. More specifically, the present invention relates to a paint can pour spout device that can be attached to a paint can and used to pour liquid from the can through a spout of the device 100 in a controlled manner. Accordingly, the present disclosure makes specific reference thereto. Nonetheless, it is to be appreciated that aspects of the present invention are also equally applicable to other like applications, devices, and methods of manufacture.

### BACKGROUND

Pouring paint or stain from a can into a tray or other container is an everyday task for many, but it is often far more time-consuming, messy, and inconvenient than one might expect. As the liquid pours out, it frequently runs down the outside of the can, causing unsightly drips that not only make the can difficult to handle but also lead to the paint or stain hardening over time. Once dried, this residue can build up in the lid groove, making it challenging to reseal the can properly and ultimately shortening the life of the leftover product inside. In some cases, the inability to close the can tightly can even result in the liquid drying out completely, rendering the remaining contents unusable.

Additionally, liquid splatter during the pouring process is a common issue that can lead to unexpected stains on the floor, work surfaces, or surrounding objects, particularly when the person pouring isn't able to control the flow. These splatters can easily ruin nearby furniture or tools and are particularly problematic for outdoor surfaces like driveways or patios, where stains may be difficult to remove. Worse still, the person pouring often ends up with paint or stains splashed onto their clothing or skin, leading to further cleanup that extends beyond just the project at hand. Many people have found themselves needing to stop mid-task to deal with unintended spills or splatter, which can slow down the entire painting or staining process.

Therefore, there exists a long-felt need in the art for a device that improves the paint-pouring process. There also exists a long-felt need in the art for a paint can pour spout device. More specifically, there exists a long-felt need in the art for a paint can pour spout device that prevents spillage and splattering while pouring paint or other liquid from a can.

The subject matter disclosed and claimed herein, in one embodiment thereof, comprises a paint can pour spout device. The device is comprised of a body with a half-circular shape and an integrated spout, designed for attachment to a paint can rim. The body may be formed from materials like plastic or metal, with optional protective coatings to prevent paint adhesion and ease cleaning. The device features various fasteners, including clips, flexible sections, or grooves, to secure it to the paint can, with gaskets enhancing the seal and reducing spillage. The spout is adjustable in size for different flow rates and may include a pressure release valve to ensure smooth pouring. A removable cap can also be attached to prevent drying or spillage. The method of use involves attaching the device to a paint can, pouring paint, and optionally covering the spout with the cap.

In this manner, the paint can pour spout device of the present invention accomplishes all the foregoing objectives and provides a device that improves the paint pouring process. More specifically, the device prevents spillage and splattering while pouring paint or other liquid from a can.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a paint can pour spout device. The device is comprised of a body with a generally half-circular shape, incorporating a spout into its structure. The body may be made from materials such as plastic or metal, selected for durability, cost-efficiency, and chemical resistance, particularly when in contact with paint. In one embodiment, the body includes at least one protective coating, such as silicone-based or Teflon-based, to provide a non-stick surface that facilitates easy cleaning and prevents paint from adhering or drying on the surface.

The body is configured to attach securely to a paint can rim using at least one fastener. The fastener may consist of a clip mechanism, a flexible body section adaptable to different rim sizes, or a groove or protrusion that interlocks with the rim. In some embodiments, the fastener and/or body may include at least one rubber or silicone gasket, ensuring an airtight seal to prevent paint leakage and reduce spillage.

The body also comprises at least one spout for directing paint flow, with variations in shape and size to accommodate different user needs. A wider spout may provide faster flow for larger projects, while a narrower spout allows for precision. In some embodiments, the spout is enhanced with a pressure release valve to prevent vacuum formation, ensuring smooth paint flow. Additionally, the spout may be equipped with a removable cap that prevents paint from drying or spilling when not in use, secured by various fastening mechanisms such as threaded connections or snap-fit systems.

The method of use involves providing the device, attaching it to the paint can rim via the fastener, pouring paint through the spout, and optionally placing a cap over the spout to prevent spillage.

Accordingly, the paint can pour spout device of the present invention is particularly advantageous as it provides a device that improves the paint pouring process. More specifically, the device prevents spillage and splattering while pouring paint or other liquid from a can. In this manner, the paint can pour spout device overcomes the limitations of existing methods of pouring liquid from cans known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a paint can pour spout device of the present invention in accordance with the disclosed architecture;

FIG. 2 illustrates a perspective view of one potential embodiment of a paint can pour spout device of the present invention while attached to and partially covering the opening of a paint can in accordance with the disclosed architecture;

FIG. 3 illustrates a perspective view of one potential embodiment of a paint can pour spout device of the present invention while attached to and fully covering the opening of a paint can in accordance with the disclosed architecture; and

FIG. 4 illustrates a flowchart of a method of using one potential embodiment of a paint can pour spout device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that improves the paint pouring process. There also exists a long-felt need in the art for a paint can pour spout device. More specifically, there exists a long-felt need in the art for a paint can pour spout device that prevents spillage and splattering while pouring paint or other liquid from a can.

The present invention, in one exemplary embodiment, is comprised of a paint can pour spout device. The device comprises a body with a generally half-circular shape, integrating a spout into its structure. The body may be formed from materials such as plastic or metal, chosen for their durability, cost-effectiveness, and resistance to chemicals, especially in contact with paint. In one embodiment, the body includes at least one protective coating, such as silicone-based or Teflon-based, providing a non-stick surface that facilitates easy cleaning and prevents paint from adhering or drying.

The body is designed to attach securely to the rim of a paint can using at least one fastener. The fastener may include a clip mechanism, a flexible body section that adapts to various rim sizes, or a groove or protrusion that interlocks with the rim. In some cases, the fastener and/or body may include at least one rubber or silicone gasket to create an airtight seal, preventing paint leakage and reducing spillage.

The body also incorporates at least one spout for directing paint flow, with variations in shape and size to suit different user needs. A wider spout may allow for faster flow in larger projects, while a narrower spout offers greater precision. In some embodiments, the spout includes a pressure release valve to prevent vacuum formation, ensuring smooth paint flow. Additionally, the spout may feature a removable cap to prevent paint from drying or spilling when not in use, secured by fastening mechanisms such as threaded connections or snap-fit systems.

The method of use involves providing the device, attaching it to the paint can rim using the fastener, pouring paint through the spout, and optionally placing a cap over the spout to prevent spillage.

The paint can pour spout device offers advantages by improving the paint pouring process, specifically preventing spillage and splattering while pouring paint or other liquids. This device addresses the shortcomings of existing methods for pouring liquids from cans.

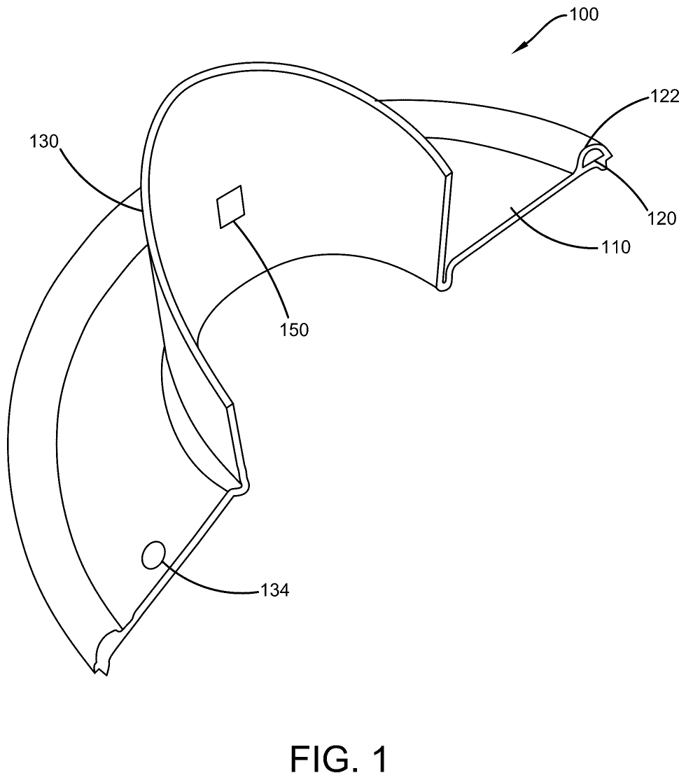

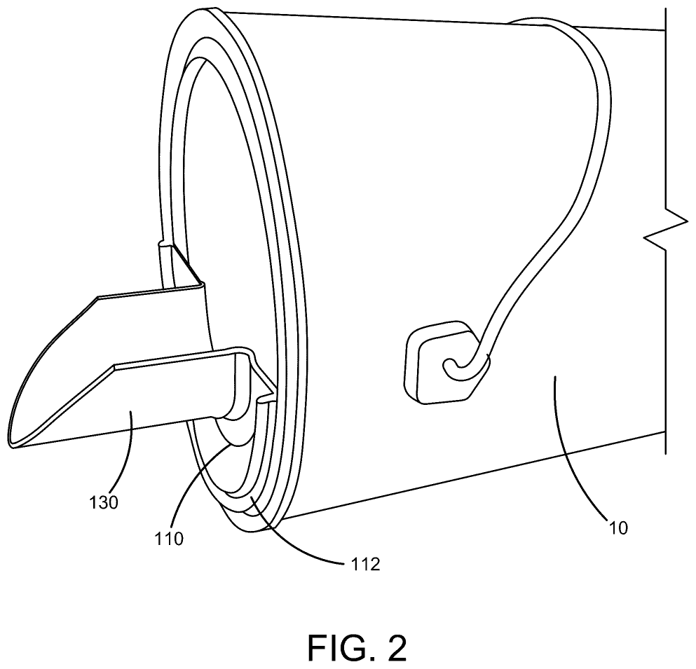

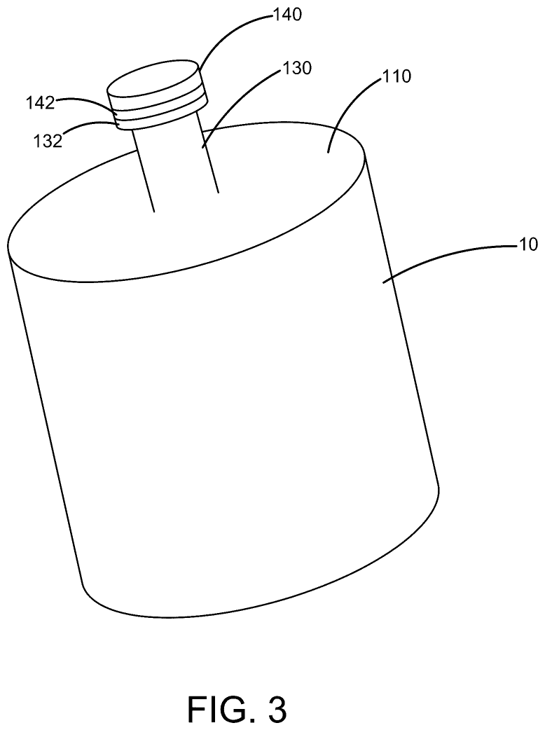

Referring initially to the drawings, FIG. 1 illustrates a perspective view of one potential embodiment of a paint can pour spout device 100 of the present invention in accordance with the disclosed architecture. The device 100 is comprised of a body 110. The body 110 has a generally half-circular shape that partially covers a paint can 10 opening (as seen in FIG. 2), with a spout 130 integrated into its structure. In one embodiment, the body 110 is circular and covers the entirety of a paint can 10 opening (as seen in FIG. 3). The body 110 may be formed from various materials, including, but not limited to, plastic or metal. These materials are selected based on durability, cost, and resistance to chemical reactions, particularly in contact with paint. In one embodiment, the body 110 is comprised of at least one protective coating 150. The coating 150 may be silicone-based, Teflon-based, or a combination of both, providing a non-stick surface that prevents paint from adhering to the device 100. This feature also allows for easy cleaning and reduces the risk of paint drying onto the surface, which could hinder the functionality of the device over time.

The body 110 is configured to attach securely to the rim of a paint can 10 through at least one fastener 112. In one embodiment, the fastener 112 is comprised of a clip mechanism designed to engage the paint can 10 rim firmly. In another embodiment, the fastener 112 is comprised of a flexible section of the body 110 itself, which can adapt to varying rim sizes, ensuring a snug fit. In a further embodiment, the fastener 112 is comprised of a groove or protrusion on the body 110 that interlocks with the paint can 10 rim, securing the device 100 in place during use. Additionally, in some embodiments, the fastener 112 and/or body 110 may be supplemented with at least one rubber and/or silicone gasket 120. The gasket 120 improves the seal between the device 100 and the paint can 10, creating an airtight fit to prevent paint leakage and reduce spillage around the edges.

The body 110 is further comprised of at least one spout 130 for directing the flow of paint from the can. The spout 130 may vary in terms of shape, size, and configuration to meet different user needs. For example, a wider spout 130 may facilitate a faster, more voluminous flow of paint, suitable for larger projects, whereas a narrower spout 130 offers greater precision and controlled flow, ideal for detail work. In one embodiment, any area of the device 100 is further enhanced by incorporating at least one pressure release valve 134. The pressure release valve 134 is designed to allow air to enter the paint can 10 while paint is being poured, which ensures a smooth and consistent flow by preventing a vacuum effect that could disrupt the pouring process.

In another embodiment wherein the body 110 covers the entire opening of a paint can 10 (as seen in FIG. 3), the spout 130 may be configured to receive at least one removable cap 140. The cap 140 serves as a protective cover when the device 100 is not in use, preventing paint from drying inside the spout 130 or from spilling unintentionally, wherein the device 100 then functions as a de-facto lid for the paint can 10. The cap 140 may be attached to the spout 130 through a pair of fasteners 132, 142. These fasteners may include, but are not limited to, reciprocating fasteners such as threaded connections, snap-fit mechanisms, or other releasable fastening systems that allow for secure yet convenient attachment and removal of the cap 140.

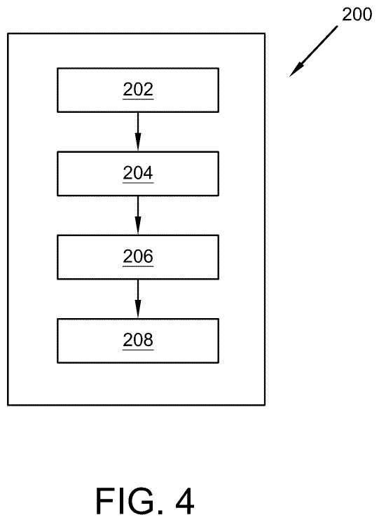

The present invention is also comprised of a method of using 200 the device 100, as seen in FIG. 4. First, a device 100 is provided comprised of a body 110 comprised of a spout 130 and a fastener 112 [Step 202]. Then, the body 110 can be attached around and/or to the rim of a paint can 10 via the fastener 112 [Step 204]. Next, the paint can 10 may be manipulated such that paint from the can is poured out of the spout 130 [Step 206]. Optionally, a user can place a cap 140 over the spout 130 as needed to prevent spillage [Step 208].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “paint can pour spout device” and “device” are interchangeable and refer to the paint can pour spout device 100 of the present invention.

Notwithstanding the foregoing, the paint can pour spout device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the paint can pour spout device 100 as shown in the FIGS. are for illustrative purposes only, and that many other sizes and shapes of the paint can pour spout device 100 are well within the scope of the present disclosure. Although the dimensions of the paint can pour spout device 100 are important design parameters for user convenience, the paint can pour spout device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A paint can pour spout device comprising:
a body comprised of a half-circular shape;
a spout integrated into the body;
a fastener configured to secure the body to a rim of a can; and
wherein the body is comprised of at least one protective coating to provide a non-stick surface.

2. The paint can pour spout device of claim 1, wherein the fastener is comprised of a clip.

3. The paint can pour spout device of claim 1, wherein the fastener is comprised of a groove.

4. The paint can pour spout device of claim 1, wherein the fastener is comprised of a protrusion.

5. The paint can pour spout device of claim 1, wherein the fastener is comprised of a flexible fastener.

6. The paint can pour spout device of claim 1, wherein the protective coating is comprised of a silicone coating.

7. The paint can pour spout device of claim 1, wherein the protective coating is comprised of a Teflon coating.

8. The paint can pour spout device of claim 1 further comprised of a gasket.

9. A paint can pour spout device comprising:
a body comprised of a half-circular shape;
a spout integrated into the body, the spout comprised of a pressure release valve;
a fastener configured to secure the body to a rim of a can; and
a gasket.

10. The paint can pour spout device of claim 9 further comprised of a cap.

11. The paint can pour spout device of claim 10, wherein the cap is received by the spout.

12. The paint can pour spout device of claim 10, wherein the cap is comprised of a first fastener.

13. The paint can pour spout device of claim 10, wherein the first fastener is comprised of a threaded fastener.

14. The paint can pour spout device of claim 10, wherein the first fastener is comprised of a snap-fit fastener.

15. The paint can pour spout device of claim 10, wherein the spout is comprised of a second fastener.

16. The paint can pour spout device of claim 10, wherein the second fastener is comprised of a threaded fastener.

17. A method of using a paint can pour spout device, the method comprising the following steps:
providing a paint can pour spout device comprised of a body, a spout, and at least one fastener;
attaching the body to the rim of a can using the fastener; and
manipulating the paint can such that a liquid is poured through the spout;
optionally placing a removable cap over the spout to prevent spillage when the device is not in use.

18. The method of using a paint can pour spout device of claim 17 further comprised of a step of placing a removable cap over the spout to prevent spillage when the paint can pour spout device is not in use.

19. The method of using a paint can pour spout device of claim 17, wherein the removable cap is comprised of a first fastener.

20. The method of using a paint can pour spout device of claim 19, wherein the spout is comprised of a second fastener.
